(19) United States
(12) Patent Application Publication
(10) Pub. No.: US 2025/0324986 A1
(43) Pub. Date: Oct. 23, 2025

(54) METHOD FOR PRODUCING ARTIFICIAL RICE MADE FROM SOYBEANS

(71) Applicant: FUJICCO CO., LTD., Hyogo (JP)

(72) Inventors: Nobuhiro SUDO, Hyogo (JP); Wataru INAGUMA, Hyogo (JP); Kentaro MARUYAMA, Hyogo (JP); Mayu KIMURA, Hyogo (JP)

(73) Assignee: FUJICCO CO., LTD., Hyogo (JP)

(21) Appl. No.: 18/855,534

(22) PCT Filed: May 17, 2022
(86) PCT No.: PCT/JP2022/020575

§ 371 Date: May 22, 2025

(51) Int. Cl. A21D 2/26; A21D 8/04

(52) U.S. Cl. CPC A21D 2/266; A21D 8/042

(57) ABSTRACT

Provided is artificial rice using soybeans as a raw material, which is high in protein, low in carbohydrates, and excellent in texture. A method for producing artificial rice includes a kneading step, a forming step, and a drying step. In the kneading step, water is added to a raw material containing soy flour, soybean protein, and transglutaminase and the raw material is kneaded, thereby obtaining a kneaded material. In the forming step, the kneaded material is extruded and formed into a rice-shaped product. In the drying step, the rice-shaped product is dried. Temperature in the kneading step and the forming step is 40° C. or lower. Temperature in the drying step is 30 to 100° C. A weight ratio between the soy flour and the soybean protein in the raw material is 30:70 to 90:10.

### TECHNICAL FIELD

The present disclosure relates to a method for producing artificial rice using soybeans as a raw material. More specifically, the present disclosure relates to a method for producing artificial rice which is high in protein, low in carbohydrates, and excellent in texture, using soybeans as a primary ingredient.

### BACKGROUND ART

Since rice as the staple food for Japanese is rich in starch and relatively high-calorie, patients with obesity, diabetes, or the like may limit intake thereof and an increasing number of people are unable to feel satisfied after having a daily meal.

Then, various low-calorie foods have been developed. For example, proposed are artificial rice using starch, dextrin, a gelling agent, and a clouding agent (JP-A-H06-225719), and a low-calorie food in the shape and size of grains of cooked rice containing glucomannan as a main ingredient, starch, dietary fiber, and a polysaccharide thickener (JP-A-H06-315356).

Furthermore, in recent years, malnutrition and weakness (frailty) associated with decreased food intake, and an age-related decline in muscle mass (onset of sarcopenia) are becoming a problem for elderly people. In “Dietary Reference Intakes for Japanese, 2020” (Ministry of Health, Labor and Welfare), it is recommended to take a sufficient amount of protein every day from the viewpoint of preventing frailty in the elderly people. Meanwhile, rice as the staple food for Japanese is low in protein and it is not possible to take the required intake of protein from rice alone. Therefore, there has been a demand for development of high-protein artificial rice that can be a substitute rice as the staple food.

For example, proposed are artificial rice using soy flour as a primary ingredient and modified starches as a secondary ingredient (JP-A-2009-153396), and a method for producing artificial rice using gluten and a soybean ingredient as a raw material (JP-A-2007-129946). These are artificial rice satisfying high-protein low-carbohydrate requirements, but there is room for further improvement in texture.

### SUMMARY

### Problems to be Solved by the Disclosure

The present disclosure has been made in view of the problems, and provides a method for producing artificial rice which is high in protein, low in carbohydrates, and excellent in texture, using soybeans as a raw material.

### Means for Solving the Problems

The inventors of the present disclosure have made extensive investigations in order to solve the problems, and as a result, unexpectedly found that artificial rice can be obtained by adding transglutaminase to soy flour and soybean protein, adding water thereto and mixing, forming the mixture into a form of grains of rice, drying the resulting rice-shaped product while activating the transglutaminase to exert the action thereof, and deactivating or inactivating the transglutaminase by heating and/or decreasing a moisture content during the drying; and the artificial rice obtained in this manner retains the form of grains of rice without crumbling while being cooked, has hardness, elasticity, and the like similar to those of cooked rice, and is excellent in texture, making it a substitute for cooked rice.

Furthermore, the inventors of the present disclosure found that the artificial rice enables to provide protective food against frailty and sarcopenia or a low-carbohydrate diet, which is high in protein, low in carbohydrates, and excellent in texture.

Specifically, the present disclosure provides the followings.
[1] A method for producing artificial rice includes a kneading step, a forming step, and a drying step. In the kneading step, water is added to a raw material containing soy flour, soybean protein, and transglutaminase and the raw material is kneaded, thereby obtaining a kneaded material. In the forming step, the kneaded material is extruded and formed into a rice-shaped product. In the drying step, the rice-shaped product is dried. Temperature in the kneading step and the forming step is 40° C. or lower. Temperature in the drying step is 30 to 100° C. A weight ratio between the soy flour and the soybean protein in the raw material is 30:70 to 90:10 (soy flour:soybean protein).
[2] In the method for producing artificial rice according to [1], the total amount of the soy flour and the soybean protein contained in the raw material may be 50 parts by weight or more relative to 100 parts by weight of total solid ingredients contained in the raw material.
[3] In the method for producing artificial rice according to [1] or [2], the raw material further may contain starches.

Furthermore, the present disclosure provides the followings.
[4] In the method for producing artificial rice according to [3], the weight ratio between the soy flour and the soybean protein in the raw material may be 30:70 to 50:50 (soy flour:soybean protein), and the amount of the starches may be 30 parts by weight or less relative to 100 parts by weight of total solid ingredients.
[5] In the method for producing artificial rice according to [3] or [4], the starches may be one or more selected from a group consisting of glutinous rice flour, rice flour, modified starch, and resistant maltodextrin.
[6] A method for producing artificial rice includes a kneading step, a forming step, and a drying step. In the kneading step, water is added to a raw material containing soy flour, soybean protein, and transglutaminase and the raw material is kneaded, thereby obtaining a kneaded material. In the forming step, the kneaded material is extruded and formed into a rice-shaped product. In the drying step, the rice-shaped product is dried. In the drying step, the transglutaminase is activated under a predetermined temperature condition to exert an action of the transglutaminase on protein contained in the soy flour and the soybean protein.

### Effects of the Disclosure

According to the present disclosure, it is possible to provide artificial rice which retains the form of grains of rice without crumbling while being cooked, has hardness, elasticity, and the like similar to those of cooked rice, and is excellent in texture, making it a substitute for cooked rice.

### EMBODIMENTS OF THE DISCLOSURE

Hereinafter, the present disclosure will be described in more detail. However, these are merely one exemplary embodiment of the present disclosure and the present disclosure is not limited to these contents.

Note that “X and/or Y (X and Y are each a given configuration)” as described herein means at least one of X and Y, i.e. three meanings: only X, only Y, and X and Y.

A raw material of artificial rice according to one exemplary embodiment of the present disclosure (hereinafter may be referred to as “the present artificial rice”) contains at least transglutaminase, and soy flour and soybean protein as primary ingredients. Additionally, it optionally contains a secondary ingredient such as starches.

### (Soy Flour)

General soy flour can be used as the soy flour used in the raw material of the present artificial rice. Specifically, exemplary soy flour is obtained by pulverizing, heating as appropriate, and drying dehulled soybeans. From the viewpoint of flavor, such as an unpleasant odor and taste peculiar to soybeans, it is preferable to use soy flour with deactivated enzyme activity of lipoxygenase and the like by heat treatment.

Exemplary soybeans that can be used in the raw material of the soy flour include, but are not particularly limited to, whole soybeans, dehulled soybeans, and ground soybeans. These can be used alone or in combination of two or more.

Exemplary types of soybeans usable for the soy flour include yellow soybeans, white soybeans, green soybeans, black soybeans, Kurakake-mame, and the like, but are not particularly limited thereto and may be appropriately selected depending on desired flavor. These can be used alone or in combination of two or more. Furthermore, white soybeans or yellow soybeans are preferred from the viewpoint of a color tone, for example, to make the color tone closer to white rice.

An exemplary method for processing the soy flour includes processes of dehulling, heating, then pulverizing, and drying soybeans. Although not particularly limited, the heating process may be performed either before or before and after the dehulling process, or after the pulverizing process. Furthermore, when soybeans dehulled in advance are used, the dehulling process is not required.

The dehulling process of soybeans is not particularly limited, and any known method generally used may be employed. Specific examples thereof include a grinding method, dry-milling method, dry-dehulling method using a stone mill, polishing method, instantaneous heating method, and the like, which may be performed using a commercially available dehuller. When using the heating method, it is possible to deactivate or inhibit enzyme activity of lipoxygenase and the like by heating, simultaneously with the dehulling process.

The heating process of soybeans is not particularly limited as long as it can deactivate or inhibit enzyme activity of lipoxygenase and the like by heating. Any known method generally used may be employed. The heating method may be either dry or wet heating, and the dry heating includes roasting, heating with hot air, and the like.

The pulverizing process of soybeans is not particularly limited, and any known method generally used may be employed. Examples of the pulverization method include dry pulverization, wet pulverization, freeze pulverization, and the like, which may be performed by using a commercially available pulverizer. Although not particularly limited, a particle size of the soy flour to be obtained is, for example, 100 μm or less, preferably 25 μm or less. From the viewpoint of improvement in texture of the artificial rice to be ultimately obtained, the smaller the particle size of the soy flour the better. Although not particularly limited, the lower limit of the particle size of the soy flour to be obtained is, for example, 20 μm or more.

A use amount of the soy flour can be adjusted depending on the intended texture, flavor, and formability of the artificial rice. By adjusting a weight ratio (mixing ratio) to the soybean protein as described later, it is possible to obtain the present artificial rice having excellent taste and texture.

### (Soybean Protein)

The soybean protein used in the raw material of the present artificial rice is not particularly limited. For example, any of a soybean protein isolate, a soybean protein concentrate, or a combination thereof is usable.

The soybean protein isolate is obtained by removing non-protein compounds from defatted soybeans and for example, making the resultant in a purified form having a protein content of about 90% by weight or more on a dry matter basis. For example, a commercial product can be used as the soybean protein isolate, or the soybean protein isolate can be prepared by using soybean protein as the raw material.

The soybean protein concentrate is obtained by removing most of oils and fats as well as soluble non-protein compounds from defatted soybeans and for example, making the resultant in a purified form having a protein content of about 70% by weight or more on a dry matter basis. For example, a commercial product can be used as the soybean protein concentrate, or the soybean protein concentrate can be prepared by using soybean protein as the raw material.

Exemplary forms of the soybean protein include powder, granular, and fibrous forms, but the soybean protein used for the present artificial rice is powdered. It is not preferable to use granular or fibrous soybean protein which tends to cause nonuniform texture and appearance.

A use amount of the soybean protein can be adjusted depending on the intended texture, flavor, and formability of the artificial rice. By adjusting the weight ratio (mixing ratio) to the soy flour as described above, it is possible to obtain the present artificial rice having excellent taste and texture.

### (Weight Ratio (Mixing Ratio) Between Soy Flour and Soybean Protein)

The weight ratio (mixing ratio) between the soy flour and the soybean protein can be adjusted depending on the intended texture, flavor, and formability of the artificial rice. The weight ratio between the soy flour and the soybean protein in the raw material is in the range of 30:70 to 90:10 (soy flour:soybean protein), for example. Adjustment within this range is preferred since it leads to favorable formability. Particularly, the weight ratio is preferably in the range of 30:70 to 80:20, more preferably in the range of 30:70 to 50:50.

When the amount of the soy flour is too small relative to the amount of the soybean protein, the kneaded material of the soy flour and the soybean protein tends to be less sticky, resulting in poor formability in a step of extruding and forming the kneaded material into the rice-shaped product.

Furthermore, when the amount of the soy flour is too large relative to the amount of the soybean protein, the kneaded material tends to be excessively sticky, such that the rice-shaped product formed by extruding the kneaded material sticks together rather than breaks apart, resulting in poor formability.

The total amount of the soy flour and the soybean protein as primary ingredients in the raw material of the present artificial rice is preferably 50 parts by weight or more relative to 100 parts by weight of total solid ingredients contained in the raw material. It is more preferably 60 parts by weight or more, further preferably 70 parts by weight or more relative to 100 parts by weight of the total solid ingredients. If the total amount of the soy flour and the soybean protein is too small, formability tends to be poor. Although not particularly limited, the upper limit thereof is, for example, 95 parts by weight or less, or may be 100 parts by weight.

### (Transglutaminase)

The transglutaminase used in the raw material of the present artificial rice is capable of catalyzing crosslinking via an isopeptide bond between a glutamic acid residue and a lysine residue to polymerize protein contained in the soy flour and the soybean protein as described above, thereby imparting elasticity to the protein.

The transglutaminase used in the raw material of the present artificial rice may be any conventionally known transglutaminase. For example, it may be a commercial product, or may be prepared using any raw material and a known method. Examples of the commercial product include ACTIVA TG-H, ACTIVA TG-K, ACTIVA TG-M, ACTIVA TG-AK, ACTIVA TG-B, and ACTIVA TG-S (all available from Ajinomoto Co., Inc.). Such transglutaminase may be used alone or in combination of two or more.

A use amount of the transglutaminase can be adjusted depending on the intended texture of the artificial rice. Although not particularly limited, the use amount of the transglutaminase is, for example, 0.005 to 1.0 parts by weight, preferably 0.08 to 0.5 parts by weight, and more preferably 0.01 to 0.2 parts by weight relative to 100 parts by weight of the total solid ingredients from the viewpoint of imparting elasticity to the texture of the artificial rice.

### (Secondary Ingredient)

The secondary ingredient used in the raw material of the present artificial rice is not essential, but can be used as appropriate for the purpose of adjusting or enhancing at least one or more of the intended texture, flavor, formability, and shelf life of the artificial rice. Examples of the secondary ingredient include, but are not particularly limited to, starches such as rice flour and modified starch, polysaccharide thickeners such as alginic acid, saccharides other than starches such as monosaccharide and dextrin, dietary fiber ingredients such as cellulose, and the like. These secondary ingredients can be used alone or in combination of two or more.

When the secondary ingredient is used, the amount of the secondary ingredient contained in the raw material is not particularly limited but typically 0.1 parts by weight or more, for example, 3 parts by weight or more, preferably 5 parts by weight or more, more preferably 8 parts by weight or more, and further preferably 10 parts by weight or more relative to 100 parts by weight of the total solid ingredients. Although not particularly limited, the upper limit is, for example, less than 50 parts by weight, 40 parts by weight or less, or 35 parts by weight or less.

### (Starches)

Raw materials and types of the starches used as the secondary ingredient of the present artificial rice are not particularly limited, and examples thereof include: grain starches such as rice flour, glutinous rice flour, corn starch, waxy corn starch, potato starch, sweet potato starch, tapioca starch, and cassava starch; and modified starches such as highly branched cyclic dextrin, heat-moisture treated starch, hydroxypropyl starch, starch acetate, hydroxyalkyl starch, and distarch phosphate. These can be used alone or in combination of two or more.

Although not particularly limited, the amount of the starches is 3 parts by weight or more, preferably 5 parts by weight or more, more preferably 8 parts by weight or more, and further preferably 10 parts by weight or more relative to 100 parts by weight of the total solid ingredients. Although not particularly limited, the upper limit is, for example, less than 50 parts by weight, 40 parts by weight or less, or 35 parts by weight or less.

When the starches are included, for example, artificial rice having flavor peculiar to cooked rice tends to be easily obtained.

### (Polysaccharide Thickener)

Examples of the polysaccharide thickener used as the secondary ingredient of the present artificial rice include, but are not particularly limited to, sodium alginate, propylene glycol alginate, gum arabic, arabinogalactan, alginic acid, gum ghatti, curdlan, carrageenan, glucomannan, furcelleran, gum karaya, locust bean gum, xanthan gum, gellan gum, native gellan gum, guar gum, psyllium seed gum, Tamarindus indica seed gum, tara gum, gum tragacanth, pectin, pullulan, welan gum, cassia gum, gelatin, agar, and the like. These can be used alone or in combination of two or more.

Although not particularly limited, the amount of the polysaccharide thickener is 0.1 parts by weight or more, preferably 0.2 parts by weight or more, more preferably 0.5 parts by weight or more, and further preferably 1 parts by weight or more relative to 100 parts by weight of the total solid ingredients. Although not particularly limited, the upper limit is, for example, less than 10 parts by weight, 8 parts by weight or less, or 5 parts by weight or less.

When the polysaccharide thickener is included, for example, elastic and sticky texture is easily imparted to the present artificial rice, and water retention tends to be easily enhanced.

### (Dietary Fiber Ingredient)

Examples of the dietary fiber ingredient used as the secondary ingredient of the present artificial rice include, but are not particularly limited to, cellulose, polydextrose, resistant maltodextrin, enzyme hydrolyzed guar gum, low molecular weight sodium alginate, psyllium husk, inulin, soluble soybean polysaccharides, gum arabic, corn fiber, and the like. These can be used alone or in combination of two or more.

Although not particularly limited, the amount of the dietary fiber ingredient is 1 parts by weight or more, preferably 2 parts by weight or more, more preferably 3 parts by weight or more, and further preferably 5 parts by weight or more relative to 100 parts by weight of the total solid ingredients. Although not particularly limited, the upper limit is, for example, less than 50 parts by weight, 40 parts by weight or less, or 35 parts by weight or less.

When the dietary fiber ingredient is included, for example, elastic and sticky texture is easily imparted to the present artificial rice, and water retention and flavor tend to be easily enhanced.

(Saccharides Other than Starches)

The saccharides other than starches used as the secondary ingredient of the present artificial rice are not particularly limited. For example, any edible saccharides are usable. Specific examples thereof include reduced sugar syrup such as glucose, fructose, galactose, mannose, maltose, lactose, sucrose, trehalose, maltitol, and sorbitol. These can be used alone or in combination of two or more.

Although not particularly limited, the amount of the saccharides other than starches is 3 parts by weight or more, preferably 5 parts by weight or more, more preferably 8 parts by weight or more, and further preferably 10 parts by weight or more relative to 100 parts by weight of the total solid ingredients. Although not particularly limited, the upper limit is, for example, less than 50 parts by weight, 40 parts by weight or less, or 35 parts by weight or less.

When the saccharides other than starches are included, for example, it tends to be easy to impart an effect of making the present artificial rice fluffy when cooked or left for a while after cooking, a suppression effect on hardening of protein, a suppression effect on aging of starch, etc.

Among the secondary ingredients, the starches and the dietary fiber ingredient are preferred; glutinous rice flour, rice flour, modified starch, and resistant maltodextrin are more preferred; and the glutinous rice flour is further preferred.

Note that in addition to the above ingredients, known ingredients and additives used in the art can also be used in the raw material of the present artificial rice. However, it is preferable not to include either one of or both of animal protein and wheat protein from an allergy-free point of view.

A method for producing the present artificial rice (hereinafter may be referred to as “the present production method”) is characterized in processes of adding water to soy flour, soybean protein, and transglutaminase and kneading them to form a rice-shaped product, drying the rice-shaped product while activating the transglutaminase to exert an action of the transglutaminase on protein, and deactivating or inactivating the transglutaminase by heating and/or decreasing a moisture content during the drying. Specifically, the present production method as described later includes a kneading step, a forming step, and a drying step.

### (Kneading Step)

The kneading step in the present production method is a step of adding water to a raw material containing soy flour, soybean protein, and transglutaminase and kneading the raw material, thereby obtaining a kneaded material. For example, firstly, the soy flour and the soybean protein as primary ingredients are homogeneously mixed to obtain a powder mixture. When a secondary ingredient is used, it is mixed with the primary ingredients. Next, the transglutaminase is dissolved in cold water, and the resulting solution is mixed with the powder mixture and kneaded.

In the kneading step, an addition amount of the water upon kneading can be set as appropriate. For example, the water is added in an amount of preferably 30 to 60 parts by weight, more preferably 45 to 55 parts by weight, where the total weight of the raw material including the water corresponds to 100 parts by weight. If the addition amount of the water is too large or too small, forming defects tend to occur in the forming step. Furthermore, if the addition amount of the water is too low, the action of the transglutaminase tends to be insufficient in the drying step, resulting in difficulty in obtaining preferable texture.

In order not to accelerate the reaction between the transglutaminase and the protein contained in the raw material, the kneading step is performed under a condition that a material temperature of the kneaded material is at a predetermined temperature or lower. For example, the material temperature of the kneaded material is preferably no higher than 40° C. or lower than 40° C., more preferably 35° C. or lower, further preferably 30° C. or lower, and particularly preferably 25° C. or lower. Although not particularly limited, the lower limit of the material temperature of the kneaded material is, for example, 0° C. or higher. The primary ingredients and the secondary ingredients in the raw material are preferably cooled in a refrigerator in advance.

The kneading method may be any method capable of homogenously mixing the raw material. The types of a kneader are not particularly limited, but preferred is the one equipped with a cooling chiller.

### (Forming Step)

The forming step in the present production method is a step of extruding and forming the kneaded material obtained in the kneading step into a rice-shaped product. For example, the kneaded material obtained in the kneading step is fed to an extruder such as a screw extruder, extruded and cut through a die section provided on the tip of the extruder while being further kneaded, and formed into a form of grains of rice. The kneaded material is compressed and extruded in the forming step, such that a rice-shaped product having a fine structure can be obtained. The types of the extruder are not particularly limited, and a squeezer or other extruders is usable. Preferred is the one equipped with a cooling chiller.

In order not to accelerate the reaction between the transglutaminase and the protein contained in the raw material, the forming step is performed under a condition that the material temperature of the kneaded material is at a predetermined temperature or lower. For example, the material temperature of the kneaded material is preferably no higher than 40° C. or lower than 40° C., more preferably 35° C. or lower, further preferably 30° C. or lower, and particularly preferably 25° C. or lower. Although not particularly limited, the lower limit of the material temperature of the kneaded material is, for example, 0° C. or higher.

When the material temperature of the kneaded material is too high in the kneading step and the forming step, activation of the transglutaminase in the kneaded material is enhanced, and the once structured material collapses upon extrusion, resulting in reduced shape retention of the resulting rice-shaped product and a tendency for a lot of cracks and scraps to occur. Furthermore, too much elasticity tends to be imparted to the artificial rice as a final product, resulting in difficulty in obtaining preferable texture.

### (Drying Step)

The drying step in the present production method is a step of drying the rice-shaped product obtained in the forming step to obtain the present artificial rice. For example, the rice-shaped product obtained in the forming step is dried using a dryer under a predetermined temperature condition while activation of the transglutaminase is being enhanced. As the drying further progresses, the rice-shaped product is dried to a predetermined dry state, and at the same time, the transglutaminase is deactivated or inactivated, thereby obtaining the present artificial rice.

In the drying step, for example, drying using a dryer at 100° C. or lower not only enables to produce a less discolored product with a good color tone, but also enables to accelerate the reaction between the transglutaminase and the protein at the same time. This causes the protein in the rice-shaped product to be crosslinked with each other and polymerized, such that the present artificial rice can be provided with suitable elasticity and improved shape retention, resulting in the artificial rice with excellent texture and cooking resistance.

Temperature in the drying step is preferably 100° C. or lower, more preferably 30 to 100° C., and further preferably 50 to 100° C. The drying step is preferably performed for 30 to 210 minutes. Particularly preferably, the temperature in the drying step is 60 to 90° C. and the duration of the drying step is 35 to 90 minutes. Drying under these conditions is preferable because a product with good texture and color tone can be obtained, and also high drying efficiency and short drying time, thus high productivity can be achieved. Although the lower limit of the temperature in the drying step is not particularly limited, drying at low temperature is not preferable because of poor drying efficiency and longer drying time.

In the predetermined dry state in the present production method, a moisture content of the artificial rice after drying is preferably 12% by weight or less, more preferably 10% by weight or less, and further preferably 8% by weight or less from the viewpoint of deactivation or inactivation of the transglutaminase. Furthermore, by reducing the moisture content of the artificial rice after drying to the above range, deterioration and browning due to microorganisms can favorably be suppressed during storage.

Furthermore, the dryer for use is not particularly limited. For example, hot air band drying, hot air fluidized drying, hot air shelf-type drying, or the like can be employed.

In a case where a dryer using hot air as described above is used in the drying step, the rice-shaped product is placed inside a drying chamber, and air at a predetermined temperature is blown to the rice-shaped product to evaporate/dissipate moisture by heat of the air. The ambient temperature in the drying chamber (set temperature for the dryer) is preferably 30 to 100° C., more preferably 50 to 100° C., and further preferably 60 to 90° C. The duration of the drying step is preferably 30 to 210 minutes, more preferably 35 to 90 minutes.

The present artificial rice obtained by the present production method can be eaten after the present artificial rice, just as it is, is cooked alone in a usual manner. The present artificial rice can also be mixed with polished rice, unpolished rice, and the like as appropriate, cooked, and then eaten.

Accordingly, the present production method enables to produce the present artificial rice usable as a substitute for cooked rice, which retains the form of grains of rice without crumbling while being cooked, has hardness and elastic texture similar to those of cooked rice, and is further high in protein, low in carbohydrates, and excellent in taste and texture.

Furthermore, the present production method enables to produce the present artificial rice usable as high-protein low-carbohydrate protective food against frailty and sarcopenia or low-carbohydrate diet.

### EXAMPLES

Next, the present disclosure will be described with reference to examples. However, the present disclosure is not limited to these examples.

### Examples 1 and 2, Comparative Examples 1 to 3

Examples and Comparative Examples below were, unless otherwise specified, produced using the following ingredients and conditions.

### (Production of Artificial Rice)

Firstly, a production method of Example 1 will be described below.

Soy flour, powdered soybean protein (available from FUJI OIL Co., Ltd., soybean protein isolate), and transglutaminase (available from Ajinomoto Co., Inc.) were used in a raw material.

The soy flour was obtained by heating whole soybeans (“Hokkaido Toyomasari”) with hot air at 115° C. for 20 minutes, then dehulling the soybeans by a dehuller and pulverizing by a pulverizer. The soy flour thus obtained had an average particle diameter of 20 to 30 μm.

Next, 2000 g of the soy flour and 2750 g of the soybean protein kept refrigerated at 10° C. or lower were mixed to obtain a powder mixture, then 1 g of the transglutaminase was dissolved in 5249 g of water at 10° C., and these were mixed and homogenously kneaded to obtain a kneaded material. In this case, a material temperature of the kneaded material was no higher than 20° C.

Next, the kneaded material was fed to a screw extruder equipped with a molding die section on the tip thereof, extruded by circulating chiller water (10° C.) in an outer ring jacket of an extruder rotor, and at the same time cut into a rice-shaped product. A product temperature of the rice-shaped product on this occasion was no higher than 25° C. Note that the size of the rice-shaped product was adjusted to length of 7 mm×width of 2 mm×thickness of 2 to 3 mm.

Next, the rice-shaped product was fed to a steam convection oven (available from fujimak corporation, product number FCCM6), and hot air shelf-type drying was performed at 80° C. (set temperature for the oven) for 45 minutes without humidification to activate the transglutaminase to exert the action thereof during the drying, thereby obtaining a sample of artificial rice of Example 1.

A sample of Example 2 was obtained in the same manner as in Example 1 except that the soybean protein in the raw material was changed from the soybean protein isolate to a soybean protein concentrate (available from MATSUDA SANGYO Co., Ltd.) in Example 2.

As comparative examples, each sample was obtained in the same manner as in Example 1 except the raw material, that is, soy flour only (Comparative Example 1) and soybean protein only (Comparative Example 2) were used with transglutaminase, and soy flour and soybean protein, but no transglutaminase were used (Comparative Example 3). Note that respective numerical values in Table 1 represent % by weight per total weight of the raw material.

### (Cooking of Artificial Rice)

To 200 g of the artificial rice obtained in Examples and Comparative Examples, 400 g of water was added, and the rice was cooked in a usual manner using a rice cooker. The artificial rice in the rice cooker was stirred well with a rice scoop and thereafter steamed in the rice cooker for 10 minutes.

### (Evaluation of Artificial Rice)

The artificial rice obtained in Examples and Comparative Examples was evaluated for formability of the artificial rice in the production and sensory evaluation of the cooked artificial rice (texture, appearance, taste/flavor).

For the sensory evaluation, 5 panelists who were trained for preference sensory evaluation performed tasting and evaluation in accordance with the evaluation criteria below, and the results thereof were aggregated. Note that forming defects were not worthy to taste, and thus no tasting evaluation was conducted. The results thereof are shown in Table 1.

### [Formability Evaluation Criteria]

⊚ (excellent): smooth grain surface, formable without crumbling or cracking.
∘ (very good): formable without crumbling or cracking.
Δ (good): formable but a little crumbling.
x (poor): not formable, or too much crumbling or cracking.

### [Evaluation Criteria for Tasting Evaluation]

### (Texture)

⊚ (excellent): rice-like texture, tasty.
∘ (very good): moderate texture, tasty.
Δ (good): a bit bad texture, less tasty.
x (poor): bad texture, not tasty.

### (Appearance)

∘ (very good): good appearance with less discoloration, crumbling while cooking, or binding.
Δ (good): inferior appearance, problems with any of discoloration, crumbling while cooking, and binding.
x (poor): bad appearance, many problems with any of discoloration, crumbling while cooking, and binding.

### (Taste/Flavor)

∘ (very good): not scorched, no bitter taste, tasty with soybean flavor.
Δ (good): a little scorched and bitter taste, or inferior flavor with less soybean flavor.
x (poor): scorched, bitter taste, not tasty.

TABLE 1

| | | Example | Example | Comparative | Comparative | Comparative |
|---|---|---|---|---|---|---|
| | | 1 | 2 | example 1 | example 2 | example 3 |
| Soy flour | | 20.1 | 20.1 | 47.6 | — | 20.1 |
| Soybean | Isolate | 27.5 | — | — | 47.6 | 27.5 |
| protein | Concentrate | — | 27.5 | — | — | — |
| Transglutaminase | | 0.01 | 0.01 | 0.01 | 0.01 | — |
| Water | | 52.4 | 52.4 | 52.4 | 52.4 | 52.4 |
| Formability | | ◯ | ◯ | X | X | ◯ |
| evaluation | | | | | | |
| Tasting | Texture | ◯ | ◯ | — | — | X |
| evaluation | Appearance | ◯ | ◯ | — | — | X |
| | Taste/flavor | ◯ | ◯ | — | — | ◯ |

In the tasting evaluation in Table 1, “—” represents “not evaluated”.

According to the results in Table 1, when the soy flour, the soybean protein, and the transglutaminase were used (Examples 1 and 2), artificial rice with more preferable formability and texture was obtained, which further had more preferable appearance and taste/flavor.

On the other hand, when the soy flour was used alone, not in combination with the soybean protein (Comparative Example 1), excessive stickiness caused forming defects; when the soybean protein was used alone, not in combination with the soy flour (Comparative Example 2), dough was non-sticky to hold together, and could not be formed. Furthermore, when the transglutaminase was not used (Comparative Example 3), the formability was good but both the texture and the appearance were poor due to gelation during cooking of the rice. Furthermore, for the type of soybean protein, strength of stickiness and adhesiveness vary depending on the type, but both the soybean protein isolate (Example 1) and the soybean protein concentrate (Example 2) were able to provide favorable texture.

### [Example 1, Comparative Example 4]: Examination of Enzyme Reaction Step

A test was conducted where the transglutaminase was activated to exert the action thereof in the kneading step of Example 1. Specifically, 2000 g of the soy flour and 2750 g of the soybean protein stored at room temperature were mixed to obtain a powder mixture, then 1 g of the transglutaminase was dissolved in 5249 g of water at 50° C., and these were mixed and homogenously kneaded. The material temperature of the kneaded material was 40° C. immediately after the kneading. The kneaded material was put in a bag and sealed, which was thereafter placed in an incubator and kept at 40° C. for 1 hour. Then, the kneaded material was fed to an extruder and dried to obtain a sample of artificial rice of Comparative Example 4. Note that the forming step and the drying step were performed under the same conditions as in Example 1. Each evaluation was performed in the same manner as in Example 1, and the results thereof are shown in Table 2.

TABLE 2

| | | | | Comparative |
|---|---|---|---|---|
| | | | Example 1 | example 4 |
| Transglutaminase | | | Drying | Kneading |
| reaction step | | | step | step |
| Formability evaluation | | | ◯ | Δ |
| | Tasting | Texture | ◯ | X |
| | evaluation | Appearance | ◯ | X |
| | | Taste/flavor | ◯ | ◯ |

As described above, when the transglutaminase was activated to exert the action thereof in the drying step (Example 1), artificial rice with more preferable formability and texture was obtained, which further had more preferable appearance and taste/flavor.

On the other hand, according to the results in Table 2, when the transglutaminase was activated to exert the action thereof in the kneading step (Comparative Example 4), the artificial rice could be formed but crumbled a little, and also lost its shape after cooked, resulting in poor texture.

### [Examples 3 and 4, Comparative Examples 5 and 6]: Examination of Temperature Conditions for Kneading Step and Forming Step

The temperature conditions for the kneaded material from the kneading step to the forming step were examined. Specifically, temperature of water to be added was adjusted such that the material temperature of the kneaded material from the kneading step to the forming step would be no higher than 25° C. (Example 3), higher than 25° C. but no higher than 40° C. (Example 4), higher than 40° C. but no higher than 45° C. (Comparative Example 5), and higher than 45° C. but no higher than 50° C. (Comparative Example 6). The process from the start of the kneading step to the end of the forming step was carried out within 20 minutes and the resulting granular product was dried, thereby obtaining each sample of artificial rice. Note that the conditions other than the temperature conditions from the kneading step to the forming step were the same as in Example 1. Each evaluation was performed in the same manner as in Example 1, and the results thereof are shown in Table 3.

TABLE 3

| | | | | Comparative | Comparative |
|---|---|---|---|---|---|
| | | Example 3 | Example 4 | example 5 | example 6 |
| Temperature of | | No higher | Higher | Higher | Higher |
| kneaded material | | than 25° C. | than 25° C. | than 40° C. | than 45° C. |
| | | | but no higher | but no higher | but no higher |
| | | | than 40° C. | than 45° C. | than 50° C. |
| Formability | | ◯ | Δ | Δ | Δ |
| evaluation | | | | | |
| Tasting | Texture | ◯ | Δ | X | X |
| evaluation | Appearance | ◯ | Δ | Δ | Δ |
| | Taste/flavor | ◯ | ◯ | ◯ | ◯ |

According to the results in Table 3, when the material temperature of the kneaded material was no higher than 40° C. from the kneading step to the forming step (Examples 3 and 4), artificial rice with preferable formability, texture, and the like was obtained. Particularly, when the material temperature of the kneaded material was no higher than 25° C. from the kneading step to the forming step, artificial rice with more preferable formability, texture, and the like was obtained.

On the other hand, when the material temperature of the kneaded material was higher than 40° C. from the kneading step to the forming step (Comparative Examples 5 and 6), cooked artificial rice had too strong elasticity due to excessive activation and action of the transglutaminase, resulting in poor texture.

### [Example 1, Comparative Example 7]: Examination of Necessity of Drying Process

A test was conducted where the transglutaminase was activated to exert the action thereof under no-drying conditions in the drying step of Example 1. Specifically, the rice-shaped product obtained in the forming step was put in a bag and sealed, which was thereafter fed to an incubator (available from Yamato Scientific Co., Ltd., product number DKN602) and after the product temperature reached 55° C., kept as was for 60 minutes to activate the transglutaminase to exert the action thereof, thereby obtaining a sample of artificial rice of Comparative Example 7. Note that the kneading step and the forming step were performed under the same conditions as in Example 1. Each evaluation was performed in the same manner as in Example 1, and the results thereof are shown in Table 4.

TABLE 4

| | | | | Comparative |
|---|---|---|---|---|
| | | | Example 1 | example 7 |
| Drying process | | | Performed | Not performed |
| Formability evaluation | | | ◯ | ◯ |
| | Tasting | Texture | ◯ | Δ |
| | evaluation | Appearance | ◯ | X |
| | | Taste/flavor | ◯ | ◯ |

As described above, when the drying process was performed to obtain the artificial rice in a dry state (Example 1), artificial rice with more preferable texture and the like was obtained, which further had more preferable appearance and taste/flavor.

On the other hand, according to the results in Table 4, when the drying process was not performed (Comparative Example 7), the texture was dry and crumbly. Furthermore, the appearance was also bad.

### [Examples 5 to 8, Comparative Example 8]: Examination of Weight Ratio (Mixing Ratio) Between Soy Flour and Soybean Protein

A test was conducted where only the weight ratio (mixing ratio) between the soy flour and the soybean protein in the raw material of Example 1 was changed. Specifically, only the weight ratio (mixing ratio) between the soy flour and the soybean protein was changed as in Table 5, while the water and the transglutaminase contents were the same as in Example 1, thereby obtaining each sample of artificial rice. Note that the kneading step, the forming step, and the drying step were performed under the same conditions as in Example 1. Each evaluation was performed in the same manner as in Example 1, and the results thereof are shown in Table 5. Note that respective numerical values in Table 5 represent % by weight per total weight of the raw material, and the numerical values in parentheses represent the ratio between the soy flour and the soybean protein.

TABLE 5

| | | Comparative | | | | |
|---|---|---|---|---|---|---|
| | | example 8 | Example 5 | Example 6 | Example 7 | Example 8 |
| Soy flour | | 11.9(25%) | 15.9(33%) | 23.8(50%) | 35.7(75%) | 42.8(90%) |
| Soybean protein | | 35.7(75%) | 31.7(67%) | 23.8(50%) | 11.9(25%) | 4.8(10%) |
| Transglutaminase | | 0.01 | 0.01 | 0.01 | 0.01 | 0.01 |
| Water | | 52.4 | 52.4 | 52.4 | 52.4 | 52.4 |
| Formability | | X | ◯ | ◯ | ◯ | Δ |
| evaluation | | | | | | |
| Tasting | Texture | — | ◯ | ◯ | Δ | Δ |
| evaluation | Appearance | — | ◯ | ◯ | Δ | Δ |
| | Taste/flavor | — | ◯ | ◯ | ◯ | ◯ |

In the tasting evaluation in Table 5, “-” represents “not evaluated”.

According to the results in Table 5, when the weight ratio between the soy flour and the soybean protein fell within the range of 30:70 to 90:10 (Examples 5 to 8), artificial rice with preferable formability, texture, and the like was obtained. Particularly, when the weight ratio between the soy flour and the soybean protein fell within the range of 30:70 to 50:50 (Examples 5 and 6), artificial rice with more preferable formability, texture, and the like was obtained, which further had more preferable appearance and taste/flavor.

On the other hand, when the weight ratio between the soy flour and the soybean protein was 25:75 (Comparative Example 8), dough was non-sticky to hold together, and could not be formed.

### [Examples 9 to 15, Comparative Examples 9 and 10]: Examination of Drying Temperature

A test was conducted where only the drying temperature and time in the drying step of Example 1 were changed. Specifically, drying was performed at each temperature shown in Table 6 until the moisture content became 8% by weight or less, thereby obtaining each sample of artificial rice. Note that the kneading step and the forming step were performed under the same conditions as in Example 1. Each evaluation was performed in the same manner as in Example 1, and the results thereof are shown in Table 6.

TABLE 6

| | | | | | | | | | Comp. | Comp. |
|---|---|---|---|---|---|---|---|---|---|---|
| | | Ex. | Ex. | Ex. | Ex. | Ex. | Ex. | Ex. | Ex. | Ex. |
| | | 9 | 10 | 11 | 12 | 13 | 14 | 15 | 9 | 10 |
| Drying temperature (° C.) | | 30 | 50 | 60 | 70 | 80 | 90 | 100 | 150 | 200 |
| Drying time (minutes) | | 840 | 210 | 90 | 65 | 45 | 35 | 30 | 15 | 8 |
| Formability evaluation | | ◯ | ◯ | ◯ | ◯ | ◯ | ◯ | ◯ | ◯ | ◯ |
| Tasting | Texture | Δ | Δ | ◯ | ◯ | ◯ | ◯ | Δ | X | X |
| evaluation | Appearance | ◯ | ◯ | ◯ | ◯ | ◯ | ◯ | ◯ | X | X |
| | Taste/flavor | ◯ | ◯ | ◯ | ◯ | ◯ | ◯ | Δ | Δ | X |

According to the results in Table 6, when the drying temperature was in the range of 30 to 100° C. (Examples 9 to 14), artificial rice with preferable texture and the like was obtained. Particularly, when the drying temperature was in the range of 60 to 90° C. (Examples 11 to 14), artificial rice with more preferable texture and the like was obtained, which further had more preferable appearance and taste/flavor.

One the other hand, when the drying temperature was 150° C. or higher (Comparative Examples 9 and 10), texture was inferior and further discoloration and scorching impaired the appearance.

### [Example 16]: Examination of Secondary Ingredient

A test was conducted where a part of the soy flour and the soybean protein in the raw material of Example 1 was replaced with modified starch as the secondary ingredient. Specifically, 1590 g of the soy flour and 2170 g of the soybean protein were mixed with 1000 g of modified starch (available from Matsutani Chemical Industry Co., Ltd., heat-moisture treated starch) to obtain a powder mixture, and then a sample of artificial rice of Example 16 was obtained in the same manner as in Example 1. Note that the kneading step, the forming step, and the drying step were performed under the same conditions as in Example 1. Each evaluation was performed in the same manner as in Example 1, and the results thereof are shown in Table 7. Note that respective numerical values in Table 7 represent % by weight per total weight of the raw material, and the numerical values in parentheses represent proportions of the soy flour, the soybean protein, and the modified starch.

TABLE 7

| | | | Example | Example |
|---|---|---|---|---|
| | | | 1 | 16 |
| Soy flour | | | 20.1(42%) | 15.9(33%) |
| Soybean protein | | | 27.5(58%) | 21.7(46%) |
| Modified starch | | | — | 10.0(21%) |
| Transglutaminase | | | 0.01 | 0.01 |
| Water | | | 52.4 | 52.4 |
| Formability evaluation | | | ◯ | ⊚ |
| | Tasting | Texture | ◯ | ⊚ |
| | evaluation | Appearance | ◯ | ◯ |
| | | Taste/flavor | ◯ | ⊚ |

According to the results in Table 7, even when the secondary ingredient was used together with the soy flour and the soybean protein (Example 16), artificial rice with more preferable formability, texture, and the like was obtained, which further had more preferable appearance and taste/flavor.

### [Examples 17 to 29]: Examination of Weight Ratio (Mixing Ratio) of Soy Flour, Soybean Protein, and Secondary Ingredient

Samples of artificial rice of Examples 17 to 29 were obtained in the same manner as in Example 1 except that the combination of ingredients constituting the solid content of the raw material, and the weight ratio (mixing ratio) between the ingredients were changed as shown in Tables 8 to 10. Each evaluation was performed in the same manner as in Example 1, and the results thereof are shown in Tables 8 to 10. Note that respective values in Tables 8 to 10 represent the amount (parts by weight) of each solid ingredient relative to 100 parts by weight of the total solid ingredients contained in the raw material.

As the secondary ingredient, glutinous rice flour (commercial product), rice flour (commercial product), modified starch (available from Matsutani Chemical Industry Co., Ltd., heat-moisture treated starch), and resistant maltodextrin (available from Matsutani Chemical Industry Co., Ltd.) were used.

TABLE 8

| | | Example | Example | Example | Example | Example | Example |
|---|---|---|---|---|---|---|---|
| | | 17 | 18 | 19 | 20 | 21 | 22 |
| Mixing ratio between | | 30:70 | | | | | |
| soy flour and soybean | | | | | | | |
| protein | | | | | | | |
| Soy flour | | 27 | 21 | 21 | 21 | 21 | 15 |
| Soybean protein | | 63 | 49 | 49 | 49 | 49 | 35 |
| Glutinous rice flour | | 10 | 30 | — | — | — | 50 |
| Rice flour | | — | — | 30 | — | — | — |
| Modified starch | | — | — | — | 30 | — | — |
| Resistant maltodextrin | | — | — | — | — | 30 | — |
| Formability evaluation | | ⊚ | ⊚ | ◯ | ◯ | ◯ | ◯ |
| Tasting | Texture | ◯ | ◯ | ◯ | ◯ | ◯ | ◯ |
| evaluation | Appearance | ◯ | ◯ | ◯ | ◯ | ◯ | ◯ |
| | Taste/flavor | ◯ | ◯ | ◯ | ◯ | Δ | ◯ |

TABLE 9

| | | Example | Example | Example |
|---|---|---|---|---|
| | | 23 | 24 | 25 |
| Mixing ratio between | | 40:60 | | |
| soy flour and soybean | | | | |
| protein | | | | |
| Soy flour | | 36 | 32 | 28 |
| Soybean protein | | 54 | 48 | 42 |
| Glutinous rice flour | | 10 | 20 | 30 |
| Formability evaluation | | ⊚ | ⊚ | ◯ |
| Tasting | Texture | ⊚ | ⊚ | ⊚ |
| evaluation | Appearance | ◯ | ◯ | ◯ |
| | Taste/flavor | ⊚ | ⊚ | ⊚ |

TABLE 10

| | | Example | Example | Example | Example |
|---|---|---|---|---|---|
| | | 26 | 27 | 28 | 29 |
| Mixing ratio between | | 50:50 | | | |
| soy flour and soybean | | | | | |
| protein | | | | | |
| Soy flour | | 45 | | | |
| Soybean protein | | 45 | | | |
| Glutinous rice flour | | 10 | — | — | — |
| Rice flour | | — | 10 | — | — |
| Modified starch | | — | — | 10 | — |
| Resistant maltodextrin | | — | — | — | 10 |
| Formability evaluation | | ◯ | ◯ | ◯ | ◯ |
| Tasting | Texture | ◯ | ◯ | ◯ | ◯ |
| evaluation | Appearance | ◯ | ◯ | ◯ | ◯ |
| | Taste/flavor | ◯ | ◯ | ◯ | ◯ |

According to the results in Tables 8 to 10, even when the secondary ingredient was used together with the soy flour and the soybean protein (Examples 17 to 29), artificial rice with preferable formability, texture, and the like was obtained.

Although specific embodiments of the present disclosure have been described in Examples above, Examples are for illustrative purposes only and are not to be construed as limitative. It is intended that various modifications apparent to a person skilled in the art fall within the scope of the present disclosure.

### INDUSTRIAL APPLICABILITY

The present artificial rice produced by the present production method enables to provide artificial rice usable as a substitute for cooked rice and the like, which does not crumble while being cooked, has granular quality, hardness, moistness, and elastic texture similar to those of cooked rice, and is further high in protein, low in carbohydrates, and excellent in taste and texture.

1. A method for producing artificial rice, the method comprising:
(i) adding water to a raw material comprising soy flour, soybean protein, and transglutaminase and kneading the raw material, thereby obtaining a kneaded material;
(ii) extruding and forming the kneaded material into a rice-shaped product; and
(iii) drying the rice-shaped product,
wherein temperature in (i) and (ii) is 40° C. or lower,
wherein temperature in the drying step is 30 to 100° C., and
wherein a weight ratio between the soy flour and the soybean protein in the raw material is 30:70 to 90:10.

2. The method for producing artificial rice according to claim 1, wherein the total amount of the soy flour and the soybean protein contained in the raw material is 50 parts by weight or more relative to 100 parts by weight of total solid ingredients contained in the raw material.

3. The method for producing artificial rice according to claim 1, wherein the raw material further comprises starches.
